(19) United States
(12) Patent Application Publication
(10) Pub. No.: US 2003/0027560 A1
(43) Pub. Date: Feb. 6, 2003

(54) Message forwarding system and method

(75) Inventor: Michael E. Jammal, Salem, NH (US)

Correspondence Address: Larry I. Golden, Square D Company, 1415 South Roselle Road, Palatine, IL, 60067, US

(73) Assignee: Schneider Automation Inc.

(21) Appl. No.: 09/918,659

(22) Filed: Jul. 31, 2001

(51) Int. Cl. H04M 3/42

(52) U.S. Cl. 455/417; 455/431

(57) ABSTRACT

A method and system for forwarding a message from a communication device on the ground to a passenger traveling in an airplane, is disclosed. The method and system include creating the message using a first communication device, transmitting the message to a messaging router, transmitting from the message router to the passenger through a second communication device a notification that the message is available for receipt by the passenger, requesting receipt of the message by the passenger through the second communication device, transmitting the message from the message router to the second communication device on the airplane, and receiving the message through the second communication device on the airplane.

### TECHNICAL FIELD

This invention relates to a method for forwarding a message, and more particularly, to a method and system for forwarding a message from a communication device to a passenger traveling in an airplane.

### BACKGROUND OF THE INVENTION

Today, nearly everyone has some form of wireless communication device, such as a pager or cellular telephone, so as to be in constant communication with others. Generally, there is no restriction on the use of such devices, with some exceptions, such as in a hospital and when a person is a passenger on an airplane. During various segments of the flight, passengers are restricted from using electronic communication devices, such as cellular telephones, and laptop computers. In fact, passengers are requested to turn off their electronic devices. Therefore, for a limited time, passengers are out of touch and unreachable by third parties.

In event that a passenger on an airplane in route needs to be reached by a party on the ground, there is limited and cumbersome means to try to locate a particular passenger. The third party could try to call the airline, who would then need to attempt to contact the specific airplane to get a message to the specific passenger. Alternatively, the third party could contact the airport where the plane is to land, and hope the passenger receives the message upon landing. However, and particularly in the event of an emergency, neither method is satisfactory enough to notify the passenger on an immediate basis.

The present invention is designed to solve these and other problems.

### SUMMARY OF THE INVENTION

It is an object of the invention to provide a method of sending a message to a passenger in an airplane. The method comprising creating an electronic message using a message entry device and transmitting the electronic message to a messaging service. Notification that a message is available is sent to the passenger. After requesting the message, it is then transferred from the messaging service to a central messaging hub, wherein it is delivered to a telephone or other communication device on the airplane. The message is then received in the telephone and accessed by the passenger by using the telephone or other communication device.

It is a further object of the invention to provide a system for notifying a passenger on an airplane of a message. The message can be created by a first communication device. The notification and message can be received by a second communication device. A messaging service comprising a message router is provided for transmitting the message. The messaging service also delivers the message from the messaging center to a telephone on the airplane. The telephone includes a display screen for receiving the message in the airplane, and a means for the passenger to access the message.

Other features and advantages will become apparent from review of the following figures and specification.

### BRIEF DESCRIPTION OF THE DRAWINGS

FIG. 1 is a functional block diagram of multiple embodiments of the present invention.

FIG. 2 is a flow chart diagram of multiple embodiments of the present invention.

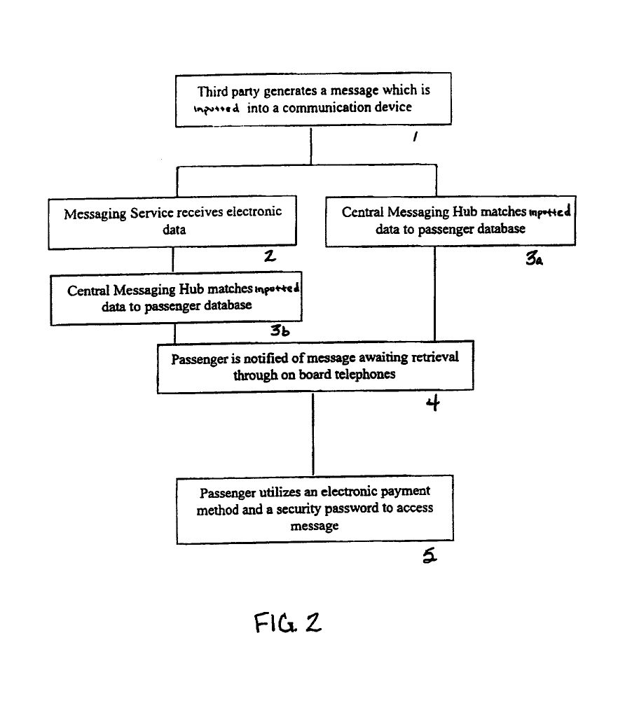

### DETAILED DESCRIPTION OF THE DRAWINGS

While this invention is susceptible of embodiment in many different forms, there is shown in the drawings and will herein be described in detail, a preferred embodiment of the invention with the understanding that the present disclosure is to be considered as an exemplification of the principles of the invention and is not intended to limit the broad aspect of the invention to the embodiment illustrated.

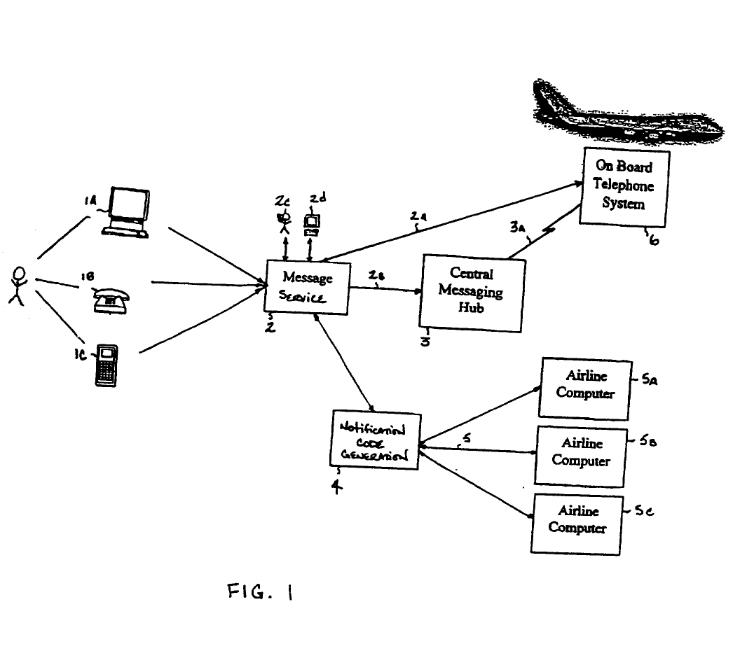

As illustrated in FIG. 1, the present invention is an improved method and system for forwarding a message to a passenger traveling in an airplane. During travel on an airplane, at certain points in the trip, passengers are required to turn off any form of communication device, such as pagers and cellular telephones. To overcome this inconvenience, many airlines offer telephone service from a stationary telephone located in a holder on the back of each passenger seat. The passenger can use the telephone to make a call to someone on the ground, but previously the telephone was not capable of receiving messages.

However, during the times when the passenger is essentially out of communication, it may be necessary to relay a message to the passenger from a person on the ground. FIG. 1 illustrates using a standard telephone 1b or cellular phone 1c, and technology which is well-known in the art, a third party 1 can call a messaging service 2, and speak with an operator 2c, who will then create an electronic message. Alternatively, the messaging service 2d may be fully automated in that the electronic message is created by voice recording. The electronic message may also be created using a computer 1a to create an e-mail that is then forwarded through a website of the messaging service 2. The e-mail message is transmitted to the messaging service for further processing.

After the message has been received by the messaging service 2, the messaging service 2 does not send the message directly to the airplane, but creates a notification code 4. The notification can consist of the target passenger's name, an alphanumeric code, or any other signal or display recognizable by a specific passenger. The notification can be transmitted directly from the messaging service to the telephone system of the airplane 2a.

In order to forward the notification 4, and eventually the message itself to the proper airplane and passenger, the messaging service needs to be able to access flight information, such as route information, flight number and the corresponding passenger's name. This information may be consolidated and accessed through a central messaging hub 3. The messaging service forwards 2b the notification to the central messaging hub 3 where specific flight information matching a target passenger with a flight can be ascertained. Using RF (TECHNOLOGY), the notification can be relayed from the central messaging hub 3 to the in-flight telephone system 6 of an airplane in route. Thus, the messaging hub 3 consolidates the notification transmission from the messaging service 2, matches the notification with a specific flight, flight location and passenger, and then places the notification in transmittable form accessible by the telephone system on the airplane.

The notification 4 is transmitted by the messaging service 2 or central messaging hub 3 to the central telephone system of the airplane 6. The telephone system may be a central system consisting of individual telephone units. The individual telephones located in a holder on the back of each passenger seat. On the back of the telephone unit facing the passenger is a liquid crystal display (LCD) display. The notification, be it a code or passenger name, enters the central telephone system of the airplane, where it is then scrolled across each LCD display on all of the telephones located in the airplane. Alternatively, if the receiving passenger's exact location is known on the airplane, the notification 4 could be directed to scroll across the telephone unit directly in front of the passenger, rather than on every telephone throughout the airplane. In this manner, the exact passenger will be alerted that a message is waiting at the messaging service 2.

Once the passenger is notified that a message is waiting to be retrieved, the passenger can request access to the message. The telephone unit will need to be activated, typically by sliding a credit card along a slot in the telephone. It may also be possible to dial in an access number to pay for use of the telephone. When the telephone on the airplane is activated, the messaging center is thereby notified that the message should be transmitted to the airplane telephone. In one embodiment 2a, the messaging service transmits the message directly to the telephone unit. In another embodiment, in the same manner that the notification was sent from a messaging service to a central messaging hub 2b, the message follows the same pathway through the central messaging hub to the telephone system on the airplane. The messaging hub contains the flight number, the in-route location if the airplane is in the air, and specific passenger information, places the message in the proper format for receipt by the telephone unit, and forwards the message to the airplane 3a.

When the message is transmitted to the airplane telephone, either by the messaging service or the central messaging hub, the passenger now has the ability to access the message. The passenger can speak directly with an operator at messaging service to retrieve the message, or the passenger can listen to the message, similar to a typical voicemail system. Optionally, the message may take the form of a text message and be scrolled over the LCD display of the telephone, just as the notification was originally displayed. The passenger may be required to enter or provide confidential information to identify the person thereby ensuring that the correct passenger receives the message.

While specific embodiments have been illustrated and described, numerous modifications come to mind without significantly departing from the spirit of the invention and the scope of protection is only limited by the scope of the accompanying Claims.

We claim:

1. A method of sending a message to a passenger in an airplane, the method comprising the steps of:
creating the message using a first communication device;
transmitting the message to a messaging router;
transmitting from the message router to the passenger through a second communication device a notification that the message is available for receipt by the passenger;
requesting receipt of the message by the passenger through the second communication device;
transmitting the message from the message router to the second communication device on the airplane; and,
receiving the message through the second communication device on the airplane.

2. The method of claim 1 wherein the message is a voice message.

3. The method of claim 1 wherein the message is a text message.

4. The method of claim 1 wherein the message is an HTML file.

5. The method of claim 1 wherein the message includes scripts.

6. The method of claim 1 further comprising the steps of transferring the notification from the messaging router to a central messaging hub before transmitting the notification to the second communication device.

7. The method of claim 1 further comprising the steps of transferring the message from the messaging router to a central messaging hub before transmitting the message to the second communication device.

8. The method of claim 1 wherein the first communication device is a telephone.

9. The method of claim 1 wherein the second communication device is a telephone.

10. The method of claim 1 wherein the first communication device is a computer.

11. The method claim 10 wherein the step of creating the message includes accessing a website.

12. The method claim 11 wherein the message router includes a server which hosts the website.

13. The method of claim 1 wherein notifying the passenger includes scrolling a code for an individual passenger across a display of the second communication device.

14. The method of claim 1 wherein notifying the passenger includes scrolling an individual passenger name across a display of the second communication device.

15. The method of claim 1 wherein requesting receipt of the message includes entering payment information into the second communication device.

16. The method of claim 15 wherein requesting receipt of the message includes swiping a credit card through a slot in the second communication device.

17. The method of claim 1 wherein delivering the message includes locating a specific airplane in route.

18. The method of claim 1 wherein delivering the message includes transmitting the message to a central communication system on the airplane.

19. The method of claim 1 wherein when the message is stored at the message router and the notification is not transmitted to the second communication device until after the plane is in route.

20. The method of claim 19 wherein the notification is sent after a predetermined delay period has elapsed once the plane is in route.

21. A system for notifying a passenger on an airplane of a message, comprising:
a first communication device for creating a message;
a message router for receiving the message and for transmitting a notification that there is a message for the passenger to the passenger on the airplane; and,
a second communication device for receiving the notification on the airplane.

22. The system of claim 21 wherein the message is a voice message.

23. The system of claim 21 wherein the message is a text message.

24. The system of claim 21 wherein the message is an HTML file.

25. The system of claim 21 wherein the message includes scripts.

26. The system of claim 21 wherein the message router receives a request from the second communication device requesting that the message be transmitted to the second communication device.

27. The system of claim 26 wherein the message router transmits the message to the second communication device for receipt by the passenger on the airplane.

28. The system of claim 27 wherein the second communication device receives the message and communicates the message to the passenger on the airplane.

29. The system of claim 27 wherein the notification, the request from the second communication device, and the transmission of the message are all roouted through a central messaging hub.

30. The system of claim 27 further comprising the step of transferring the message from the messaging router to a central messaging hub before transmitting the message to the second communication device.

31. The system of claim 21 wherein the first communication device is a telephone.

32. The system of claim 21 wherein the second communication device is a telephone.

33. The system of claim 21 wherein the first communication device is a computer.

34. The system claim 33 wherein the step of creating the message includes accessing a website.

35. The system claim 34 wherein the message router includes a server which hosts the website.

36. The system of claim 21 wherein notifying the passenger includes scrolling a code for an individual passenger across a display of the second communication device.

37. The system of claim 21 wherein notifying the passenger includes scrolling an individual passenger name across a display of the second communication device.

38. The system of claim 21 wherein requesting receipt of the message includes entering payment information into the second communication device.

39. The system of claim 38 wherein requesting receipt of the message includes swiping a credit card through a slot in the second communication device.

40. The system of claim 21 wherein delivering the message includes locating a specific airplane in route.

41. The system of claim 21 wherein delivering the message includes transmitting the message to a central communication system on the airplane.

42. The system of claim 21 wherein when the message is stored at the message router and the notification is not transmitted to the second communication device until after the plane is in route.

43. The system of claim 42 wherein the notification is sent after a predetermined delay period has elapsed once the plane is in route.
